(19) United States
(12) Patent Application Publication
(10) Pub. No.: US 2008/0083424 A1
(43) Pub. Date: Apr. 10, 2008

(54) Lotion maid

(76) Inventor: Theresa Lynn Sizelove, Box Elder, SD (US)

Correspondence Address: Theresa Sizelove, 603 Airway Ct., Box Elder, SD, 57716, US

(21) Appl. No.: 11/901,022

(22) Filed: Sep. 14, 2007

Related U.S. Application Data
(60) Provisional application No. 60/849,607, filed on Oct. 6, 2006.

(51) Int. Cl. A45D 40/26; B25G 1/04

(52) U.S. Cl. 132/320; 16/429

(57) ABSTRACT

The Lotion Maid is used to apply creams, lotions, sunblock and other preparations to the back and difficult to reach areas of the body. By simply attaching your favorite applicator by means of the clip on the end, lotions etc. can be spread on hard to reach areas.

Since the applicator can be cotton balls, washcloths or other household items they can be either disposed of or washed therefore a clean pad can be used for different lotions and several persons can use the same lotion maid making it cost effective for the entire family.

The lotion maid has a pivot near the clip so that it can glide easily across the skin and the rubberized handle makes it easy for anyone to grip it even if they have limited mobility.

### CROSS REFERENCE TO RELATED APPLICATIONS

Provisional Patent Application was assigned U.S. Application Ser. No. 60/849,607. Filing date Oct. 6, 2006.

### BACKGROUND OF THE INVENTION

1. Field of the Invention

This invention relates to devices that apply creams and lotions to a person's back.

2. Discussion of Background

It is difficult to apply creams and lotions to the back and when a person suffers from limited mobility, arthritis, or carpal tunnel, it is almost impossible to reach areas of the back and other areas on the body. The need for an applicator is apparent. It needs to be easily cleaned and the pad needs to be changed quickly and with minimum effort for different creams and lotions. It should be able to reach the back and other areas of the body with minimum effort.

### SUMMARY OF THE INVENTION

The present invention is an applicator for applying creams and lotions to the back. A variety of applicator pads may be used since the applicator end is a clip which can hold cotton balls, washcloths or other materials that are readily available to any user. The handle is one of the most important aspects of the invention. It has a large rubber grip that can easily be grasped by a user that has any problems like arthritis or carpal tunnel. This is important because persons with these or similar conditions have a hard time grasping small objects and it is painful to try and reach the middle of the back. The clip is also very important because it can hold a wide variety of applicator pads that are currently available in store and online.

### BRIEF DESCRIPTION OF THE DRAWINGS

FIG. 1 is a side view of the applicator with a side view of the clip.

FIG. 2 is a back view of the applicator.

FIG. 3 is a close up view of the clip.

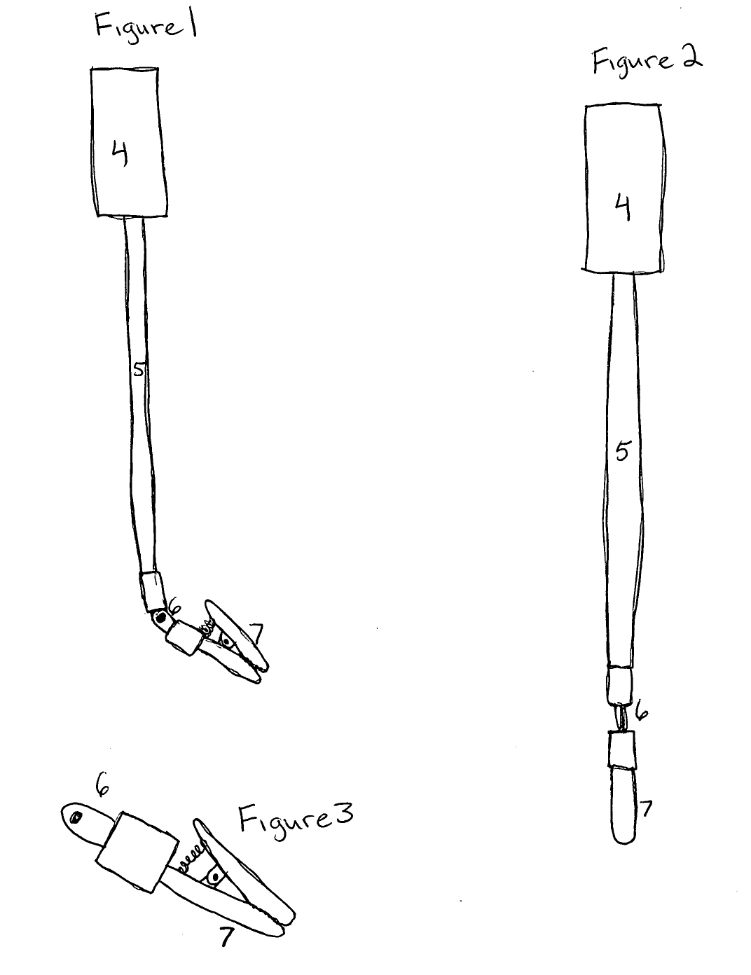

### DETAILED DESCRIPTION OF PREFERRED EMBODIMENTS

The present invention is designed to apply lotions and creams to the back but can also be used for other areas such as the feet. The invention can also be used to assist persons with limited mobility to wash as well because the applicator can hold a washcloth as well as a cotton ball or an applicator pad.

Referring now to the figures, there are five main components to the applicator. The components are handle 4, the extender 5, the rotating ring 6, and the clip 7. Handle 4 has a rubber grip and is large than the extender 5 on the applicator. This is to aid in gripping the handle without the applicator slipping out of the grasp and falling to the floor. The extender 5 is of plastic and can be retractable so that it will easily fit into a gym or beach bag to be taken anywhere it is needed. The rotating ring 6 allows the clip to pivot so that the applicator pad will glide easily over the surface of the back and can also be used on the tops or bottoms of the feet. The clip 7 is similar in design to a close pin but is larger and has curved edges so there will not be any scratching on sensitive skin areas of the back. The handle is of rubber or similar gripping material while the rest is made of plastic or acrylic. It can be made in any color to appeal to a wide variety of consumers. The applicator can be washed in soapy water or wiped clean with a cloth and any pads that are used can be washed or disposed of when they are finished being used.

It will be clear to those skilled in the art from the foregoing description that many changes and substitutions can be made to the preferred embodiments without departing from the spirit and scope of the invention, which is defined by the appended claims.

What is claimed is:

1. A hand held applicator for spreading lotions and creams on the back and other hard to reach body parts.
Said applicator comprising:
A hand held grip made of rubber.
An elongated retractable handle attached to said grip and one end and being long enough to reach all areas of the back.
A clip attached to opposite end of handle by means of a rotating ring or rotating ball.
